(19) United States
(12) Patent Application Publication
(10) Pub. No.: US 2013/0036447 A1
(43) Pub. Date: Feb. 7, 2013

(54) Attribution points for policy management

(71) Applicant: Kenneth Martinus Lassesen, Bellingham, WA (US)

(72) Inventor: Kenneth Martinus Lassesen, Bellingham, WA (US)

(73) Assignee: Kenneth Martin Lassesen, Bellingham, WA (US)

(21) Appl. No.: 13/136,510

(22) Filed: Aug. 2, 2011

(51) Int. Cl. H04L 9/32

(52) U.S. Cl. 726/1

(57) ABSTRACT

Attribution points for policy management for improvement of a determination of an access control decision; identity verification; rights management determination; or permissions inquiry. These attribution points include those between a Policy Enforcement Point and a Policy Decision Point; as well as resources for Policy Decision Point when there is not sufficient information received from the Policy Enforcement Point. Attribution Points facilitates the augmentation of attributes; speed the transmission of attributes between PEP and PDP; reduces the elapsed time for a decision; and maintains security over the attributes. An attribution point also facilitates the retrieval of attributes across zones, such as security and/or networks and/or detached systems.

INDEX OF ELEMENTS
10: Attribution Point
11: Incoming Connection
12: Outgoing Connection
13: Attribute Cache
14: Attribute Retriever
15: Attribute Encryption

### TECHNICAL FIELD

The subject matter described herein relates to an apparatus and method for improving the performance, scalability and security of policy management systems derived from the Policy Enforcement/Policy Decision Points models.

### BACKGROUND OF THE INVENTION

The current practice for policy management uses a Policy Enforcement Point [PEP] and a Policy Decision Point [PDP]. This pattern is seen in the literature and documents such as Network Working Group Request for Comments: 3198 (RFC 3198). Policy managements works off data, also known as attributes. Attributes are traditionally collected at the PEP and forwarded to the PDP. In practice this approach can result in multiple issues, such as (but not limited to), performance problems, secure-data leakage, code complexity, and scalability issues. This invention addresses these issues to improve the performance of policy management implementations by the addition of one or more Attribution Points [AP} between the PEP and the PDP. PAP may provide data real time; near-real-time: from static caches; and from third party systems. Data may be encrypted so only the PDP or specific AP may read the data, preventing secure data leakage issues. The term policy management includes: access control; usage control; rights management; policy languages; access policy; identity governance; but not restricted to those only.

### BRIEF SUMMARY OF THE INVENTION

The invention generally relates to an policy management implementation which includes Attribution Points [10] between a Policy Enforcement Point and a Policy Decision Point. Attribution Points [10] facilitates the augmentation of attributes and may speed the transmission of attributes between PEP and PDP. An attribution point also facilitates the retrieval of attributes across zones, such as security zones and/or networks zones. The number of activities occurring at the PEP may be reduced by moving the activities to a AP where those activities may be more efficiently or securely implemented. For example, a group of AP located in a distributed environment (including cloud computing) may assemble the attributes in parallel.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An objective is to provide an attribution point(s) for policy management for improvement of a determination of an access control decision or permissions inquiry.

Another objective is to provide an Attribution Point(s) for policy management that allows attributes to be effectively and/or securely gathered from entities that may exist in multiple zones.

Another objective is to provide an Attribution Point(s) for policy management that allow attributes to retrieved in an immediate, cached, cached with asynchronous update or deferred manner.

Another objective is to provide an Attribution Point(s) for policy management that will shorten the elapsed time to resolve an access permission request.

Another objective is to provide an Attribution Point(s) for policy management that simplifies the retrieval of attributes from multiple zones.

Other objectives and advantages of the present invention will become obvious to the reader and it is intended that these objectives and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: FIG. 1 is a flowchart illustrating the overall operation of the present invention. Both Policy Enforcement Point (PEP) and Policy Determination Point (PDP) are well known entity in access and permission policy literature and are not further explained.

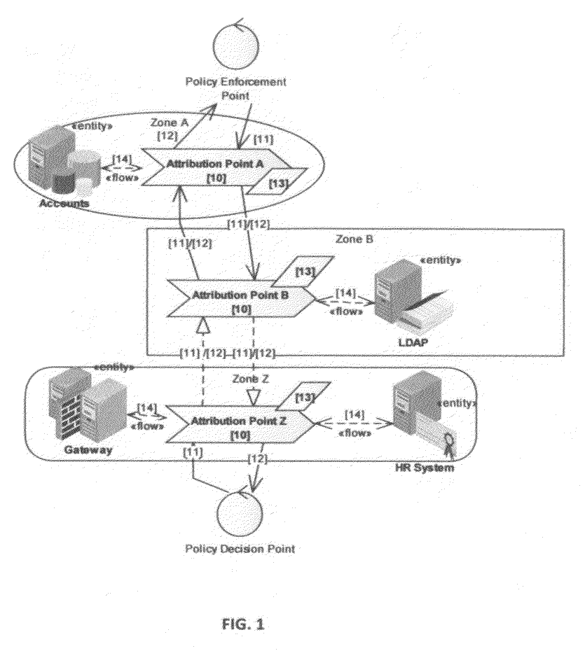

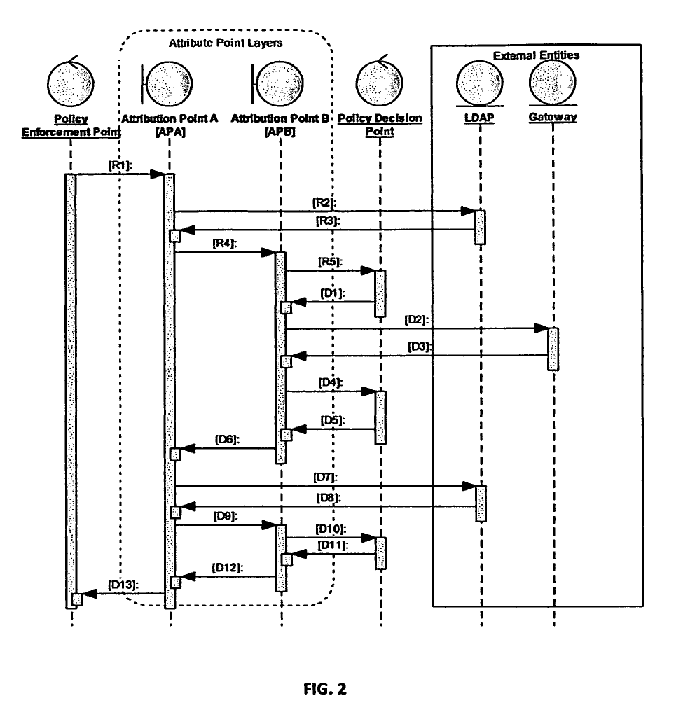

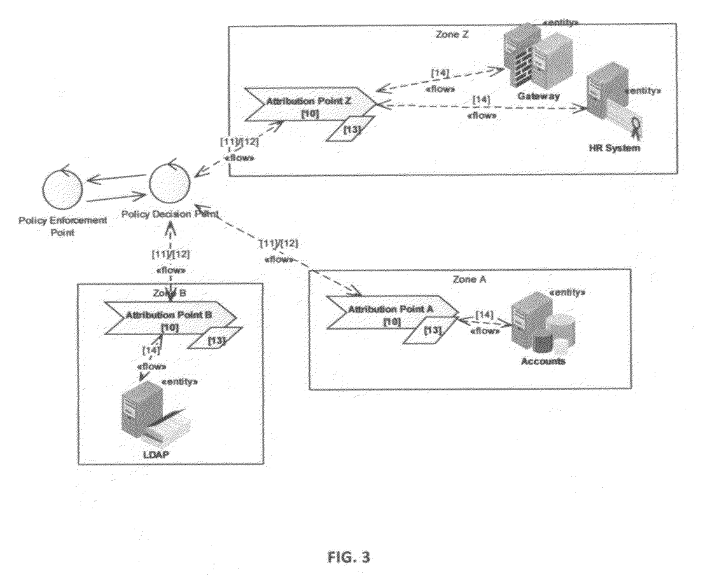

Between PEP and PDP are inserted a collection of Attribution Points [10]. Both the PEP and the PDP may contain [10] within their assemblies. [10] may exist independent of both the PEP and the PDP. Each [10] receives information from an incoming connection [11] and after any specified augmentation proceeds to forward the augmented information on the outgoing connection [12]. The augmenting information may come from an internal attribute cache [13] and from information retrieved from external entities through an attribute retriever [14].

The information augmented depends on the configuration of [10], the contents of the [13] and the contents of the [11]. Some information may be always added; some information may be conditionally added; other information may be added on explicit request only. The information added may consist of both encrypted and unencrypted information. Unencrypted information may be used by [10] for lookup of additional information. The PDP and any [10] that have been explicitly given the appropriate read keys may also the use the encrypted information. [10] typically only add data. [10] does not evaluate information, which is the role of a PDP. [10] may update information that it provided which has changed.

Unresolved decisions returning from a PDP may contain a list of attributes that are explicitly requested. Often requested attributes are items that are expensive to obtain and rarely used. When an unresolved decision is received from [11] it is examined and acted upon. [10] may proceed to return the information to the PDP; or forward the request forward to additional [10]s or the PEP; or both.

For example, an unresolved decision from the PDP may explicitly request the user's home address country and the country where their credit cards are registered. This request would arrive at Attribution Point Z where the user's home address country is retrieved [14] from the HR System. The request is then returned to the PDP. The request is also forwarded to the next [10] until it arrives at Attribution Point A where the user's credit card country is retrieved [14] from Accounts. At this point, there may be no further unfulfilled requests for attributes so the request is returned to the PDP only and not forwarded to the PEP (because it is an unresolved decision).

In some cases, a undecided request may request information that is only available at the PEP from the user. Some common examples are PIN numbers, billing address zip code and biometric identifiers.

[10] may exist in different zones, for example on isolated networks, different operating systems, or security scopes. The diagram does not imply that the routings between [10]s, PEP and PDP are fixed. Any component may directly access any other component shown when there is direct access. Components may broadcast requests by various means know to those practiced in such arts, for example, load balancing or multicasting.

FIG. 2: FIG. 2 is a flowchart illustrating the overall operation of the present invention. This sequence figure shows one possible flow of information from a Policy Enforcement Point [PEP] to a Policy Decision Point [PDP] through the invention of Attribution Points [10]. There may be multiple attribution points between a PEP and a PDP with the figure showing a simple case of 2 [10]'s.

A Request [R1] is sent to the first [10] designated [APA] where it is received as a [11]. [APA] supplies information available in its cache [13] or obtained immediately from external entities through [14] illustrated by a call [R2] to a LDAP server which returns [R3] with attributes that augments the data. The resulting data is conveyed [R4] to the next [10], designated [APB]. The information leaving APA is a [12]. The information arriving at APB is a [11]. Attributes that are immediately obtained from an external resource before passing along is termed “real time”. Attributes that are obtained from the current cache with a refresh of the cache concurrently requested is termed “near-real time”. Near-real time results eliminate the delay waiting for external resources to return results while insuring subsequent requests are based on the updated attributes in the cache. Attributes obtained from a data mart; operational data stores; data warehouse; publication to [10]; publication to a cache used by [10]; and/or other external attribute stores are termed “static cache”.

APB supplies information available in its cache [13] or obtained immediately from external entities [14]. This process may be repeated any number of times until the request [R5] reaches the PDP.

The PDP evaluates the attributes or information through one of the many mechanisms of access or policy management control. Evaluations may include Role Base Access Control; Expression Based Access Control; policy languages, for example, Ponder2; eXtensible Access Control Markup Language [XACML]; and the Usage Control [UCON] model that integrates Authorizations (A), oBligations (B) and Conditions (C) [UCON_{ABC}].

The result of the evaluation is a decision that is returned to the attribute points or directly to the PEP depending on the decision and the communication configurations. A decision may be not-sufficient information [NSI]. A list of attributes needed to make a decision may be incorporated into the decision data structure in the case of a NSI decision.

A possible [NSI] flow is illustrate by [D1] returning to [APB] as a [11]. A NSI results in the generation of an explicit request to external entities [14]; illustrated by [D2] calling a Gateway and returning with information in [D3]. [APB] may return the decision to the PDP for re-evaluation as shown by [D4] and [D5], or forward the request towards the PEP shown by [D6] or both. [APA] may also make explicit requests to external entities [14] as shown by [D7] and [D8]. APA now augments with this new data and returns it to the {PDP] through APB which may further augment or update the attributes from deferred requests to external entities. This return is illustrated by [D9], [D10]. A re-evaluation is done and the response is again sent towards the PEP through [D11], [D12] and [D13]. If a definitive decision has been made (defined as not being a NSI) then no augmentation of the Decision should occurs during the delivery to the PEP. A definitive decision may be directly sent to the PEP if the communications structures and configuration allows it.

FIG. 3: FIG. 3 is a flowchart illustrating the overall operation of the present invention. This diagram shows the placement of attribute points [10] outside of the direct flow of information between the PEP and PDP. If the PDP finds that the attributes received from the PEP is not sufficient information [NSI] then the PDP makes various requests to [10] based on the information needed. Each [10] then returns the information to the PDP for evaluation.

### DETAILED DESCRIPTION OF THE INVENTION

### A. Overview

Turning now descriptively to the drawings, in which similar reference characters denote similar elements throughout the several views, the figures illustrate Attribution Points [10] between a Policy Enforcement Point and a Policy Decision Point. Attribution Points [10] facilitates the augmentation of attributes and may speed the transmission of attributes between PEP and PDP. An attribution point also facilitates the retrieval of attributes across zones, such as security and/or networks.

### B. Attribution Point

A component that receives; processes; forwards request and decision between a Policy Enforcement Point and a Policy Decision Point [PDP]. This component may also be a provider to the PDP alone. This component [10] augments the request and decision with attributes obtained from entity or resources available within its zone. Resources include internal data stores and calls to external systems and data stores. This component [10] may return a not sufficient information (NSI) response to the PDP if [10] added or modified an attribute while concurrently continuing to forward the response towards the PEP. Each [10] may have its own routing tables, or may elect to broadcast the request and/or decision.

The Attribution Point [10] receives data originating through an incoming connection [11] from a Policy Enforcement Point [PEP] or Policy Decision Point [PDP] and augments it by adding additional information or data (collectively termed attributes). Attributes may be simple properties or complex structures of properties including, but not limited to, enumerations and hierarchical trees. Attributes may be not encrypted or encrypted. Encrypted attributes limits attribute exposure to other [10] or the [PDP]. Data originating from PEP are referred to as a Request. Data originating from PDP are referred to as a Decision. Decisions may include any or all of the data received in a Request as well as a property indicating not sufficient information to make a decision and a list of attributes that it needs to make a decision.

The attribute point may include configuration information; code or interface information on obtaining 3^{rd} party data; a data store or cache. It may expose incoming interfaces for passing requests information [11]. It may contain routines to retrieve data from external entities [14], routines to pass information to other components [12], routines to cache information. Attribution point's configuration may indicate which attributes to conditionally add depending on the information in the request, or because of self-learning from the requests flowing through it. For example, a specific type of request being returned as a NSI that specifies a needed attribute may result in that attribute being automatically added in the future.

### C. Connections of Main Elements and Sub-Elements of Invention

An attribute point contains or references one or more caches. One example implementation may be a web service (JAVA, Microsoft. Net, PHP etc.) that access a local database (MySQL, Oracle, SQL Server etc). When an incoming connection [11] receives information via a mechanism such as a web service call, JSON, COM etc., [10] proceeds to retrieve appropriate information from [13] or [14] and augment the information before making a call to place this information on the outgoing connection [12].

Both incoming and outgoing connections may use a variety of asynchronous communication techniques, for example, queues or tables. The attribute retriever [14] may also be done asynchronous—for example, a low volatility attribute may exist in the cache [13], [10] would augment with the cached value and make an asynchronous invocation of [14] to refresh the cache without impacting the speed of requests or decisions going through [10]. This process is termed near-real time attribution. Some attributes may have expiry dates, forcing periodic updates—for example, a list of current employees may be updated hourly.

Attribute encryption [15] means that a portion of the data is encrypted while other portions are un-encrypted. Different data may have different encryption. For purposes of illustrations, consider the XML Encryption Syntax and Processing standard (http://www.w3.org/TR/xmlenc-core/) where ‘the data may be arbitrary data (including an XML document), an XML element, or XML element content’. It is a common practice to serialize data as XML for transmission and thus selective encryption is well known to those practices in these arts. The encryption of each part may be different thus exposing attributes only to those components that have the appropriate keys.

### D. Alternative Embodiments of Invention

There are many variations of the above that do not use the linearity used above for purposes of explanation. As stated above, PEP, PDP and [10] may directly call each other according to configurations and connections available. For example, there may be no [10] between the PEP and the PDP, in which case the requests are directly exchanged between them. In this scenario, AP may be called by the PDP directly. If a NSI occurs at the PDP, then the requests are forwarded in parallel or series, synchronous or asynchronous, to various [10] for attribution with the results returned to the PDP. The PDP may wait until sufficient information is retrieved to make a decisions (discarding subsequent information) or until all information is retrieved. This type of behavior can be required with XACML and other policy management systems. This variation is illustrated in FIG. 3.

### E. Operation of Preferred Embodiment

The Attribution Point operates off a data store that contains information about attributes that can augment requests flowing through it. This information data store may include information on routines that can provide additional attributes and what attributes those routine required. The information data store may also include predictive information on the necessity of adding an attribute for a given request. This predictive information may be the result of self-learning as a result of implementing various methods known to practitioners of artificial intelligence systems.

Attributes may be classified into the various types, including, but not restricted to:
1) Persistent—the information exists in a cache and may be immediately added. There is no need to query external entities.
2) Immediate or real-time—the information must be retrieved from external entities immediately.
3) Deferred or near real-time—the information is available in a cache that is used to augment the request. Then a request is initiated to external entities to update the information.
4) Explicit—the information must be retrieved from external entities if a request specifies this information (implicitly or explicitly). This overrides any behavior that is configured in the AP. For example, for building access, deferred is usually sufficient however access to a vault may require real-time attributes.

Calls to external entities consume time and resources. By classification of attributes to each of these categories, performance may be optimized for throughput, resource utilization or other criteria. An example of resource utilization may be a need to balance excessive (more than the owner of the system desire) with timeliness of data (what the corporate security officer demands) which could be resolved by caching dated values in an AP. In some cases, the policy management language may impose timeliness of the attribute as a condition of evaluation and thus the same attribute may be handled differently for different requests.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed is:

1. A process for assembling the attributes or data required for policy management and decisions in a non-linear and/or distributed fashion and/or parallel fashion.
a. The process of claim 1 may be applied to Role Based Access Control and derivatives of it; to XACML and derivatives of it; to Policy Languages and derivatives of it, to any mechanism of policy management that can be expressed as a mathematical expression (including set theory) using attributes and its derivatives.
b. The process of claim 1 may be applied to accessing employee and/or student records, and/or business information and/or any item subject to digital rights management and/or physical access devices, including but not limited to, ATMs, cash registers, card readers, purchase devices, physical door access mechanisms and other systems requiring access control or policy management.
c. The process of claim 1 may result in a reduction of elapsed time to a decision.
d. The process of claim 1 may result in a reduction of load on systems in making a decision.
e. The process of claim 1 may result in a simplification of the code required to gather attributes.
f. The process of claim 1 may be applied to a cloud or grid computing environment
g. The process of claim 1 may result in a reduction of number of attributes gathered or exposed.

2. A process for securing attributes for policy managements to prevent unintended disclosure of information to fellow components, foreign systems or exposure during communication between components.
a. The process of claim 2 may be applied to Role Based Access Control and derivatives of it; to XACML and derivatives of it to Policy Languages and derivatives of it; and to any mechanism of control that can be expressed as a mathematical expression and its derivatives.
